(19) United States
(12) Patent Application Publication
(10) Pub. No.: US 2009/0086091 A1
(43) Pub. Date: Apr. 2, 2009

(54) VIDEO SIGNAL PROCESSING DEVICE AND METHOD

(75) Inventor: Hiroaki Komaki, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/236,425

(22) Filed: Sep. 23, 2008

(30) Foreign Application Priority Data
Sep. 28, 2007 (JP) 2007-255025

(51) Int. Cl. H04N 7/01; H04N 5/57

(52) U.S. Cl. 348/448; 348/687; 348/E07.003; 348/E05.119

(57) ABSTRACT

According to one embodiment, top- and bottom-field picture signals in an interlaced picture signal are stored in sequence into a frame memory. A top-field brightness conversion unit reads a top-field picture signal from the frame memory, divides an interval in which that top-field picture signal is used into four subintervals, and produces in the subintervals top-field picture signals obtained by changing the brightness of the top-field picture signal. A bottom-field brightness conversion unit reads a bottom-field picture signal from the frame memory, divides an interval in which that bottom-field picture signal is used into four subintervals, and produces in the subintervals bottom-field picture signals obtained by changing the brightness of the bottom-field picture signal. A combining unit combines the brightness changed top-field picture signals and the brightness-changed bottom-field picture signals into a frame picture signal.

### CROSS-REFERENCE TO RELATED APPLICATIONS

This application is based upon and claims the benefit of priority from Japanese Patent Application No. 2007-255025, filed Sep. 28, 2007, the entire contents of which are incorporated herein by reference.

### BACKGROUND

1. Field

One embodiment of the present invention relates to a video signal processing device and method which changes the brightness of field signals in an interlaced picture signal to produce a progressive picture signal.

2. Description of the Related Art

In recent years, the development of flat-panel display technology has allowed flat-panel display devices to be widely used as image display devices in place of cathode-ray tubes. With liquid-crystal display devices and the like which have picture hold characteristics, however, there arises a problem that afterimages are conspicuous particularly when an on-screen display (characters) in a television picture moves.

In order to make afterimages inconspicuous by simulating the impulse characteristic of cathode-ray tubes, JP-A 2004-240317 (KOKAI) discloses a hold-type display device, such as a liquid-crystal display (LCD), in which one frame is divided into two intervals, a display is made with picture data values doubled during the first interval, and residual picture data is written during the second interval only when the display range is exceeded.

However, this conventional technique is close to the black insertion processing (technique to insert a black picture between frames); therefore, there arises a problem that the entire picture will become dark or flicker will become conspicuous.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram of a video signal processing device according to an embodiment of the present invention;

FIG. 2 shows an example of a distribution of brightness in the video signal processing device;

FIG. 3 shows another example of a distribution of brightness in the video signal processing device;

FIG. 4 shows an example of a brightness characteristic which the video signal processing device of the invention are to implement;

FIG. 5 shows still another example of a distribution of brightness in the video signal processing device;

FIG. 6 shows the definitions of fields and frames in a 1080i video that the video signal processing device handles;

FIG. 7 shows the rules for brightness conversion made by the video signal processing device;

FIG. 8 shows a process of brightness conversion (75%, 100%, 75%, 50%) in a first embodiment;

FIG. 9 shows a process of brightness conversion (50%, 100%, 50%, 0%) in a second embodiment;

FIG. 10 shows a process of brightness conversion (75%, 100%, 25%, 0%) in a third embodiment;

FIG. 11 shows a process of brightness conversion (85%, 100%, 15%, 0%) in a fourth embodiment;

FIG. 12 shows a process of brightness conversion (95%, 100%, 5%, 0%) in a fifth embodiment; and

FIG. 13 is a block diagram of a digital broadcast receiver using the video signal processing device of the invention.

### DETAILED DESCRIPTION

Various embodiments of the invention will be described hereinafter. In general, according to an aspect of the invention there is provided a video signal processing device comprising: a frame memory which stores top-field picture signals and bottom-field picture signals in an interlaced picture signal in sequence; a top-field brightness conversion unit which reads a top-field picture signal from the frame memory, divides an interval in which that top-field picture signal is used into a predetermined number of subintervals, and produces in the subintervals top-field picture signals obtained by changing the brightness of the top-field picture signal, the interval in which the top-field picture signal being equal to the frame interval of the interlaced picture signal; a bottom-field brightness conversion unit which reads a bottom-field picture signal from the frame memory, divides an interval in which that bottom-field picture signal is used into the predetermined number of subintervals, and produces in the subintervals bottom-field picture signals obtained by changing the brightness of the bottom-field picture signal, the interval in which the bottom-field picture signal being equal to the frame interval of the interlaced picture signal; and a combining unit which combines the brightness-changed top-field picture signals from the top-field brightness conversion unit and the brightness-changed bottom-field picture signals from the bottom-field brightness conversion unit into a frame picture signal.

Thus, there is provided a video signal processing device and method which simultaneously realizes maintenance of average brightness, reduction in the impression of afterimage, and resistance to picture flicker for an interlaced picture signal.

The embodiments of the present invention will be described in detail hereinafter with reference to the accompanying drawings.

[Video Signal Processing Device According to an Embodiment of the Invention]

(Configuration and Operation)

FIG. 1 is a block diagram of a video signal processing device 10 according to an embodiment of the present invention. The video signal processing device 10 comprises a frame memory 1, top- and bottom-field brightness conversion units 2 and 3, and a combining unit 4. The frame memory 1 stores an interlaced picture signal of 60 fields per second (30 frames per second). The top-field brightness conversion units 2 changes the brightness of picture signals in top fields (odd fields) in the interlaced picture signal. The bottom-field brightness conversion unit 3 changes the brightness of a picture signal in bottom fields (even fields) of the interlaced picture signal. The combining unit 4 combines the brightness-changed top and bottom field picture signals.

The top-field brightness conversion unit 2 reads a top-field picture signal from the frame memory 1 and divides an interval when that field signal is used (which will be described later) into four subintervals (or it may be divided into eight subintervals or other). The conversion unit 2 then produces a top-field signal for each of the subintervals, which corresponds to the top-field picture signal read from the frame memory and having its brightness changed. Likewise, the bottom-field brightness conversion unit 3 reads a bottom-field picture signal from the frame memory 1 and divides an interval when that field signal is used into four subintervals. The conversion unit 3 then produces a bottom-field signal for each of the subintervals, which corresponds to the bottom-field picture signal read from the frame memory and having its brightness changed.

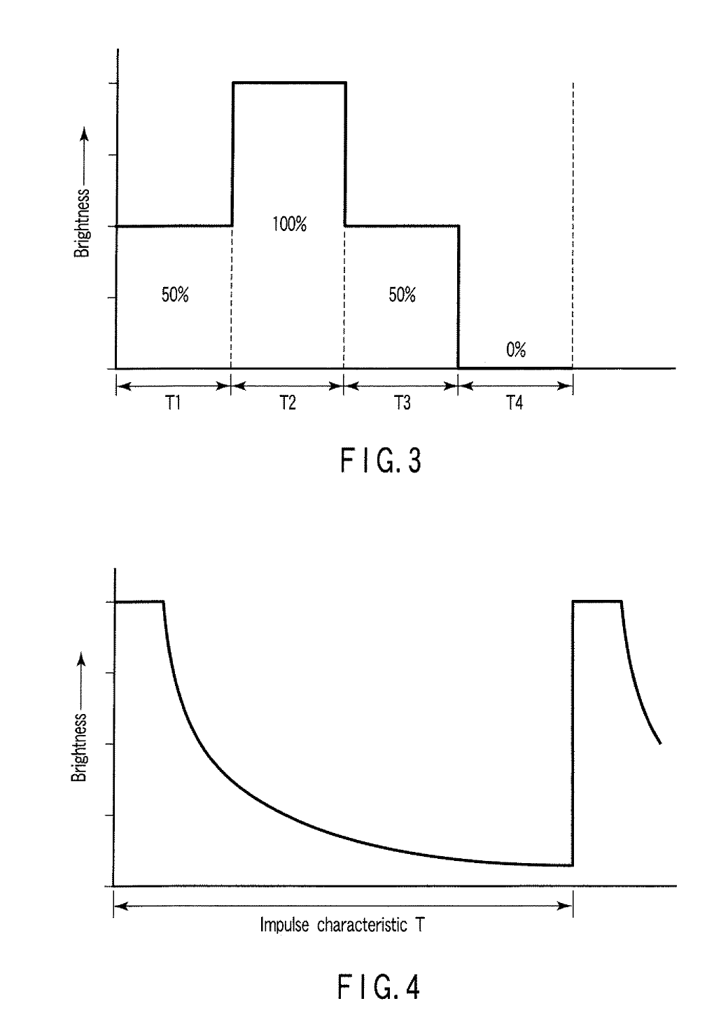

As an example of the brightness conversion in the subintervals, as shown in FIG. 3, the field brightness (picture signal) is changed to 75% of that of the input field signal in the subinterval T1, to 100% in the subinterval T2, to 75% in the subinterval T3, and to 50% in the subinterval T4. Alternatively, as shown in FIG. 3, the field brightness may be changed to 50% in the subinterval T1, to 100% in the subinterval T2, to 50% in the subinterval T3, and to 0% in the subinterval T4.

After that, the combining unit 4 combines the brightness-changed top-field signals from the top-field brightness conversion unit 2 and the brightness-changed bottom-field signals from the bottom-field brightness conversion unit 3 to output a picture signal of 120 frames per second by way of example.

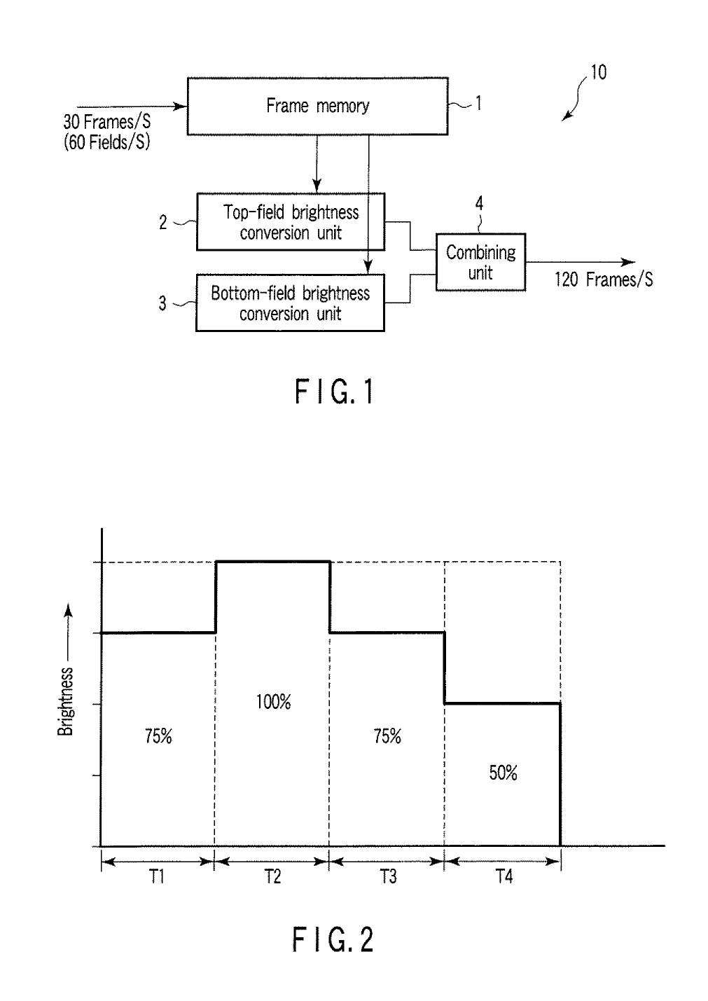

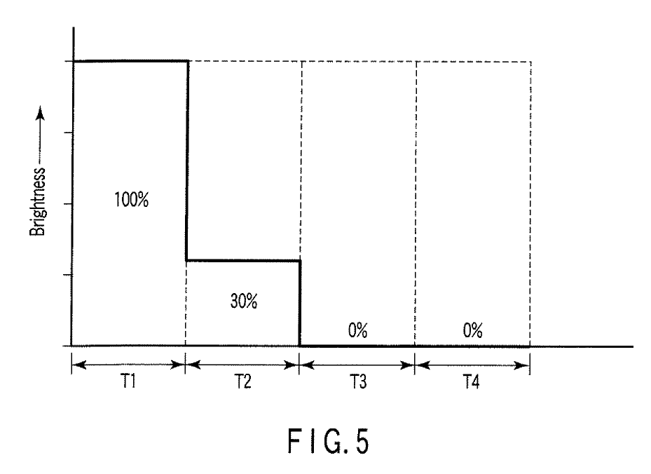

The objective of such brightness conversion is to reproduce such an impulse characteristic as shown in FIG. 4. To merely reproduce the impulse characteristic, therefore, it would be desirable to make brightness conversion in accordance with such a conversion characteristic as shown in FIG. 5. However, the characteristics required with the video signal processing device 10 are not only the reproduction of the impulse characteristic to reduce the impression of afterimage but also the maintenance of average brightness and the resistance to flicker. For this reason, such brightness characteristics as shown in FIGS. 2 and 3 are prepared for brightness conversion.

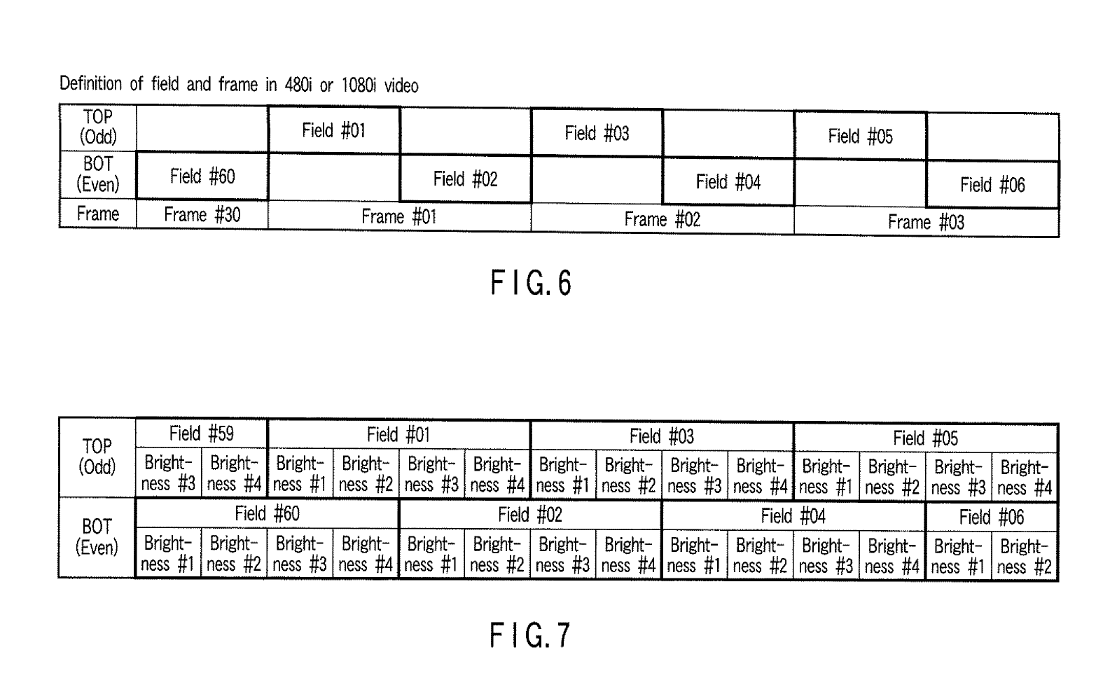

FIG. 6 illustrates definitions of field and frame in a 480i or 1080i video that the inventive video signal processing device handles. FIG. 7 illustrates the rules for brightness conversion according to an embodiment of the present invention.

In FIG. 6, with an interlaced picture signal of 60 fields per second (30 frames per second), one frame of video is made up of two top and bottom fields of video. In general, the top fields are also referred to as odd fields because the number of fields is counted beginning with 1 (as opposed to 0).

In this embodiment, pictures of 60 fields per second (30 frames per second) are converted to pictures of 120 frames per second. That is, the video signal processing device 10 does not produce frames through I/P conversion based on the conventional motion detection but changes the brightness (the value of Y in YUV) of a field signal in multiple steps (four steps at the time of conversion to 120 frames per second).

The brightness (#1, #2, #3 and #4) of FIG. 2 does not mean that #1<#2<#3<#4 but means the brightness that simulates the impulse response (interlaced video originally has) by dividing one field of data in the direction of time axis and adjusting the brightness in multiple steps.

Depending upon the conditions of interlaced picture signals and the characteristics of display, it is desirable to make brightness conversion using the characteristic shown in FIG. 2 or 3 instead of using the characteristic of FIG. 5.

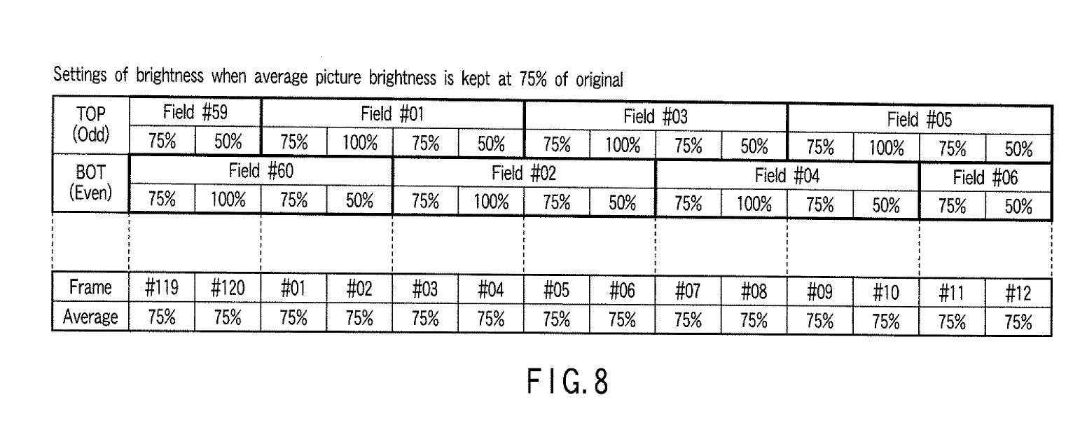

Conversion characteristics shown in FIGS. 8 through 12 will be described hereinafter.

### FIRST EMBODIMENT

FIG. 8 shows the processing of brightness conversion (75%, 100% 75%, 50%) in the first embodiment.

The interval in which each field picture signal is used (for example, Field #01) coincides in length with the frame interval of an input interlaced signal (the interval shown at, for example, Frame #01 in FIG. 6). The top-field brightness conversion unit 2 divides the interval when a top-field picture signal is used into four subintervals and produces (inserts) field signals which have their respective brightness levels changed to 75%, 100%, 75% and 50% of that of the top-field picture signal in the four subintervals.

The bottom-field brightness conversion unit 3 divides the interval when a bottom-field picture signal is used (for example, the interval shown at Field #02) into four subintervals and produces (inserts) field signals which have their respective brightness levels changed to 75%, 100%, 75% and 50% of that of the bottom-field picture signal in the four subintervals.

The interval in which a top-field picture signal is used and the interval in which a bottom-field picture signal is used are not coincident with each other but are displaced with respect to each other by one field of the input interlaced signal as shown in FIG. 8.

The combining unit 4 combines the brightness-changed top- and bottom-field signals to produce a picture signal at 120 frames per second. The average brightness of the composite picture made up of the top- and bottom-field signals corresponds to 755 of that of the original picture.

This embodiment allows the average picture brightness to be kept high and flicker to be reduced considerably. However, the effect of eliminating the impression of afterimage is small.

### SECOND EMBODIMENT

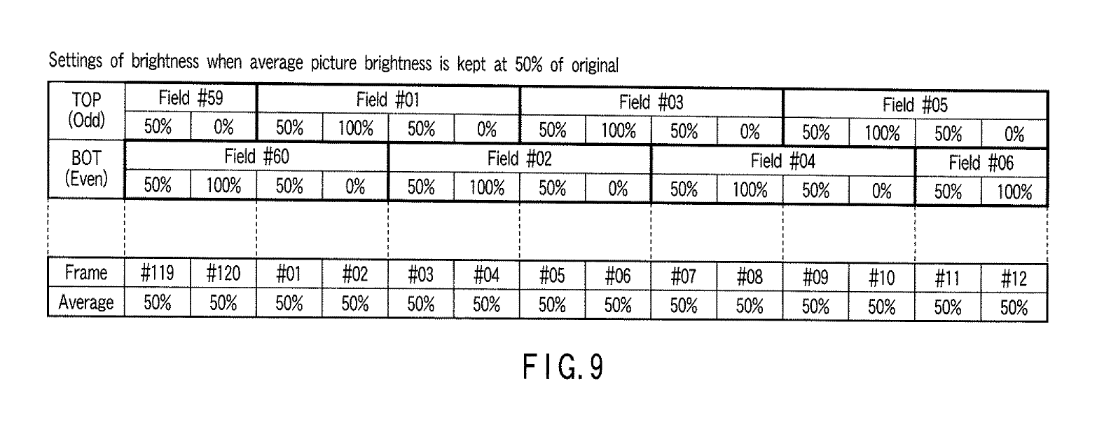

FIG. 9 shows the processing of brightness conversion (50%, 100%, 50%, 0%) in the second embodiment.

The top- and bottom-field brightness conversion units 2 and 3 each divide the interval when a field picture signal is used into four subintervals and produces field signals which have their respective brightness levels changed to 50%, 100%, 50% and 0% of that of the field picture signal in the four subintervals. The interval in which the field picture signal is used coincides in length with the frame interval of the input interlaced signal as described above. The average brightness of a composite picture made up of the top- and bottom-field signals is 50% of that of the original picture.

This embodiment allows the average picture brightness to be maintained to some degree and flicker to be reduced to some degree. In addition, the effect of eliminating the impression of afterimage can be obtained to some extent.

### THIRD EMBODIMENT

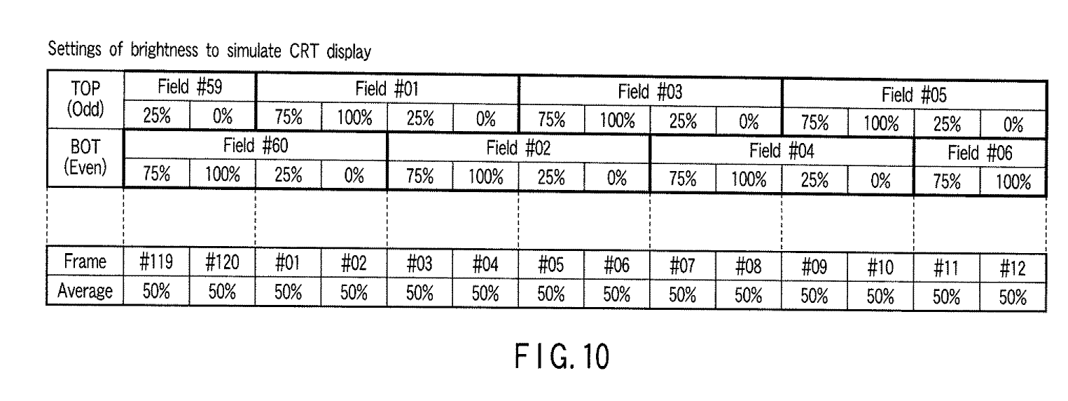

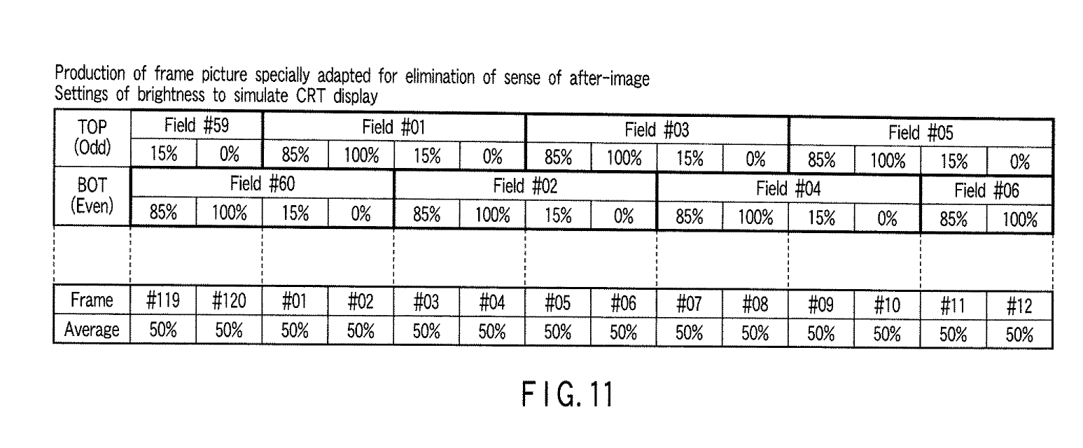

FIG. 10 shows the processing of brightness conversion (75%, 100%, 25%, 0%) in the third embodiment.

The top- and bottom-field brightness conversion units 2 and 3 each divide the interval when a field picture signal is used into four subintervals as described above and produces field signals which have their respective brightness levels changed to 75%, 100%, 25% and 0% of that of the field picture signal in the four subintervals. In this case, the average brightness of a composite picture made up of the top- and bottom-field signals is 50% of that of the original picture.

This embodiment allows the average picture brightness to be maintained to some degree and flicker to be reduced to some degree. The effect of eliminating the impression of afterimage is great.

### FOURTH EMBODIMENT

FIG. 11 shows the processing of brightness conversion (85%, 100%, 15%, 0%) in the fourth embodiment.

The top- and bottom-field brightness conversion units 2 and 3 each divide the interval when a field picture signal is used into four subintervals as described above and produces field signals which have their respective brightness levels changed to 85%, 100%, 15% and 0% of that of the field picture signal in the four subintervals. In this case, the average brightness of a composite picture made up of the top- and bottom-field signals is 50% of that of the original picture.

This embodiment allows the average picture brightness to be maintained to some degree and flicker to be reduced to some extent. The effect of eliminating the impression of afterimage is great.

### FIFTH EMBODIMENT

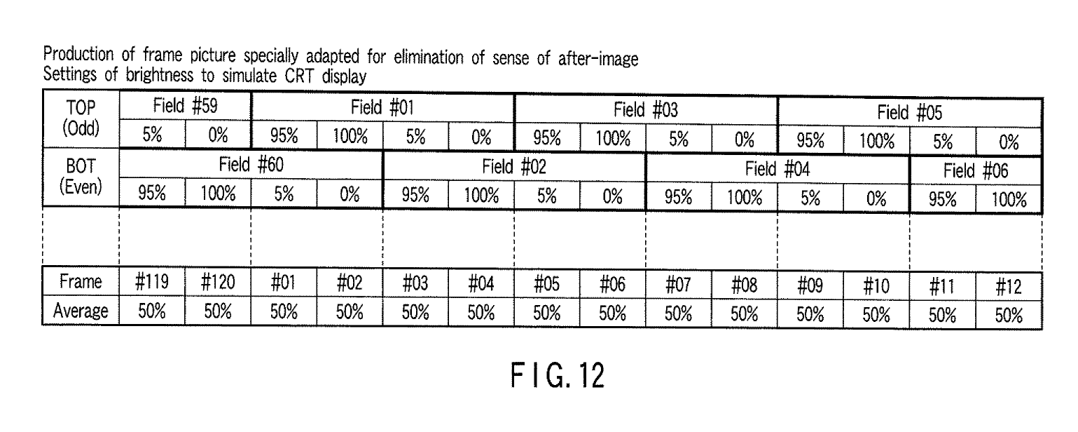

FIG. 12 shows the processing of brightness conversion (95%, 100%, 5%, 0%) in the fifth embodiment. The top- and bottom-field brightness conversion units 2 and 3 each divide the interval when a field picture signal is used into four subintervals as described above and produces field signals which have their respective brightness levels changed to 95%, 100%, 5% and 0% of that of the field picture signal in the four subintervals. In this case, the average brightness of a composite picture made up of the top- and bottom-field signals is 50% of that of the original picture.

This embodiment allows the average picture brightness to be maintained to some degree and flicker to be reduced to some degree. The effect of eliminating the impression of afterimage is great.

Thus, the user can select the brightness conversion characteristics of the video signal processing device according to circumstances to realize the maintenance of average brightness, reduction in flicker, and elimination of the impression of afterimage in a well-balanced manner.

[Broadcast Receiver Using a Video Signal Processing Unit of the Present Invention]

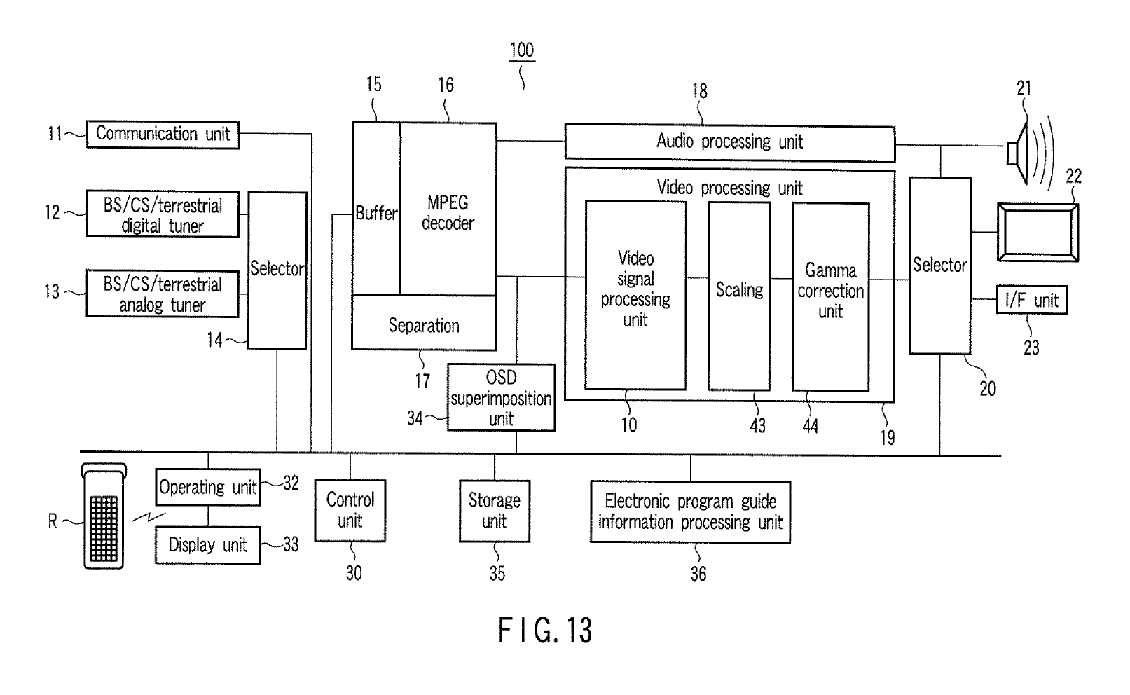

Next, a device using the video signal processing according to the present invention will be described with reference to FIG. 13, which is a block diagram of a broadcast receiver, such as a digital broadcast receiver, which uses the video signal processing according to the invention.

(Configuration and Operation of Broadcast Receiver)

A control unit 30 is connected by a data bus to each component to control the entire device. A broadcast receiver 100 includes an MPEG decoder unit 16 and the control unit 30 as the main components of the device. The broadcast receiver 100 includes an input selector 14 and an output selector 20. To the input selector 14 are connected a DBS/terrestrial digital tuner 12 and a DBS/terrestrial analog tuner 13. A communication unit 11 having a LAN or mail function is connected to the data bus.

The broadcast receiver 100 further includes a buffer 15 which temporarily stores a decoded signal from the DBS/terrestrial digital tuner 12, a separation unit 17 which separates packets forming the stored decoded signal into types, an MPEG decoder unit 16 which MPEG decodes video and audio packets from the separation unit 17 to output video and audio signals, and an on-screen display (OSD) superimposition unit 34 which produces a video signal, such as operating information, and superimposes it on a video signal. The broadcast receiver 100 further includes an audio processing unit 18 which amplifies the audio signal from the MPEG decoder unit 16, a video signal processing unit 19 which performs desired video processing on video signals from the MPEG decoder unit 16 and the OSD superimposition unit 34, a selector 20 which selects the devices to which the audio and video signals are applied, a loudspeaker 21 which outputs sound corresponding to the audio signal from the audio processing unit 18, a display unit 22, such as a liquid crystal display unit, which is connected to the selector 20 to display a video corresponding to the input video signal, and an interface unit 23 for communications with external devices.

The video signal processing unit 19 includes a video signal processing unit 10 of the present invention which subjects the brightness signal of an interlaced signal to brightness conversion, a scaling unit 43 which performs scaling, and a gamma correction unit 44 for gamma correction of a video signal.

The broadcast receiver 100 further includes a storage unit 35 to store video information from the DBS/terrestrial digital tuner 12 and the DBS/terrestrial analog tuner 13 and an electronic program guide information processing unit 36 which obtains electronic program guide information from a broadcast signal and displays it on the screen, these components being connected to the control unit 30 through the data bus. The broadcast receiver 100 further includes an operating unit 32 connected to the control unit 30 through the data bus to receive operations from the user or a remote controller R and a display unit 33 to display operating signals. The remote controller R can perform almost the same operations as the operating unit 32 incorporated into the body of the broadcast receiver 100, including the operation of the tuners.

With the broadcast receiver 100 thus configured, for example, a digital broadcast signal is input from a receiving antenna not shown to the DBS/terrestrial digital tuner and selected therein. The selected and decoded signal in the form of packets is separated into packets according to their type in the separation unit 17. The packets for audio and video are decoded in the MPEG decoder unit 16 into video and audio signals, which are in turn applied to the audio processing unit 18 and the video processing unit 19, respectively. In the video processing unit 19, the input video signal is subjected to brightness conversion in the video signal processing unit 10 and then output as a video signal with well-balanced characteristics. The video signal is then subjected to a scaling process in the scaling unit 43 and gamma correction in the gamma correction unit 44 and applied to the selector 20.

The selector 20 applies the video signal to, for example, the display unit 22 in response to a control signal from the control unit 30. Thereby, a video corresponding to the video signal is displayed on the display unit 22. In addition, sound corresponding to the audio signal from the audio processing unit 18 is emanated from the loudspeaker 21.

Operating information or subtitle information produced in the OSD superimposition unit 34 is superimposed on a video signal corresponding to a broadcast signal and the resultant video is displayed through the video processing unit 19 on the display unit 22.

The broadcast receiver 100 can realize maintenance of average brightness, resistance to picture flicker and reduction in impression of afterimage in a video displayed on the display unit 22 in a well-balanced manner by means of the video signal processing unit 10.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing device comprising:
a frame memory which stores top-field picture signals and bottom-field picture signals in an interlaced picture signal in sequence;
a top-field brightness conversion unit which reads a top-field picture signal from the frame memory, divides an interval in which that top-field picture signal is used into a predetermined number of subintervals, and produces in the subintervals top-field picture signals obtained by changing the brightness of the top-field picture signal, the interval in which the top-field picture signal being equal to the frame interval of the interlaced picture signal;
a bottom-field brightness conversion unit which reads a bottom-field picture signal from the frame memory, divides an interval in which that bottom-field picture signal is used into the predetermined number of subintervals, and produces in the subintervals bottom-field picture signals obtained by changing the brightness of the bottom-field picture signal, the interval in which the bottom-field picture signal being equal to the frame interval of the interlaced picture signal; and
a combining unit which combines the brightness-changed top-field picture signals from the top-field brightness conversion unit and the brightness-changed bottom-field picture signals from the bottom-field brightness conversion unit into a frame picture signal.

2. The video signal processing device according to claim 1, wherein the top-field brightness conversion unit divides the interval in which the top-field picture signal is used into four subintervals and produces in the four subintervals top-field picture signals which have their brightness changed to 75%, 100%, 75%, and 50%, respectively, of that of the top-field picture signal, and the bottom-field brightness conversion unit divides the interval in which the bottom-field picture signal is used into four subintervals and produces in the four subintervals top-field picture signals which have their brightness changed to 75%, 100%, 75%, and 50%, respectively, of that of the bottom-field picture signal.

3. The video signal processing device according to claim 1, wherein the top-field brightness conversion unit divides the interval in which the top-field picture signal is used into four subintervals and produces in the four subintervals top-field picture signals which have their brightness changed to 50%, 100%, 50%, and 0%, respectively, of that of the top-field picture signal, and the bottom-field brightness conversion unit divides the interval in which the bottom-field picture signal is used into four subintervals and produces in the four subintervals top-field picture signals which have their brightness changed to 50%, 100%, 50%, and 0%, respectively, of that of the bottom-field picture signal.

4. The video signal processing device according to claim 1, wherein the top-field brightness conversion unit divides the interval in which the top-field picture signal is used into four subintervals and produces in the four subintervals top-field picture signals which have their brightness changed to 75%, 100%, 25%, and 0%, respectively, of that of the top-field picture signal, and the bottom-field brightness conversion unit divides the interval in which the bottom-field picture signal is used into four subintervals and produces in the four subintervals top-field picture signals which have their brightness changed to 75%, 100%, 25%, and 0%, respectively, of that of the bottom-field picture signal.

5. The video signal processing device according to claim 1, wherein the top-field brightness conversion unit divides the interval in which the top-field picture signal is used into four subintervals and produces in the four subintervals top-field picture signals which have their brightness changed to 85%, 100%, 15%, and 0%, respectively, of that of the top-field picture signal, and the bottom-field brightness conversion unit divides the interval in which the bottom-field picture signal is used into four subintervals and produces in the four subintervals top-field picture signals which have their brightness changed to 85%, 100%, 15%, and 0%, respectively, of that of the bottom-field picture signal.

6. The video signal processing device according to claim 1, wherein the top-field brightness conversion unit divides the interval in which the top-field picture signal is used into four subintervals and produces in the four subintervals top-field picture signals which have their brightness changed to 95%, 100%, 5%, and 0%, respectively, of that of the top-field picture signal, and the bottom-field brightness conversion unit divides the interval in which the bottom-field picture signal is used into four subintervals and produces in the four subintervals top-field picture signals which have their brightness changed to 95%, 100%, 5%, and 0%, respectively, of that of the bottom-field picture signal.

7. The video signal processing device according to claim 1, wherein the field picture signals stored in the frame memory have 60 fields per second, and the frame picture signal output from the combining unit has 120 frames per second.

8. The video signal processing device according to claim 1, wherein each of the top- and bottom-field brightness conversion units divides an interval in which a field picture signal is used into eight subintervals and produces in each of the subintervals a brightness-changed field picture signal.

9. The video signal processing device according to claim 1, further comprising a tuner which receives a broadcast signal, and a decoder which decodes the broadcast signal from the tuner to apply field picture signals to the frame memory.

10. A video signal processing method comprising:
storing top-field picture signals and bottom-field picture signals in an interlaced picture signal in sequence into a frame memory;
reading a top-field picture signal from the frame memory, dividing an interval in which that top-field picture signal is used into a predetermined number of subintervals, and producing in the subintervals top-field picture signals obtained by changing the brightness of the top-field picture signal;
reading a bottom-field picture signal from the frame memory, dividing an interval in which that bottom-field picture signal is used into a predetermined number of subintervals, and producing in the subintervals bottom-field picture signals obtained by changing the brightness of the bottom-field picture signal; and
combining the brightness-changed top-field picture signals and the brightness-changed bottom-field picture signals to output a frame picture signal.
